(19) United States
(12) Patent Application Publication
(10) Pub. No.: US 2023/0032208 A1
(43) Pub. Date: Feb. 2, 2023

(54) AUGMENTING DATA SETS FOR MACHINE LEARNING MODELS

(71) Applicant: Oracle International Corporation, Redwood Shores, CA (US)

(72) Inventors: Ariel Gedaliah Kobren, Cambridge, MA (US); Naveen Jafer Nizar, Chennai (IN); Michael Louis Wick, Lexington, MA (US); Swetasudha Panda, Burlington, MA (US)

(73) Assignee: Oracle International Corporation, Redwood Shores, CA (US)

(21) Appl. No.: 17/389,900

(22) Filed: Jul. 30, 2021

(51) Int. Cl. G06N 20/00; G06K 9/62; G06F 40/247

(52) U.S. Cl. CPC G06N 20/00; G06K 9/6228; G06K 9/6256; G06F 40/247

(57) ABSTRACT

Techniques are disclosed for augmenting data sets used for training machine learning models and for generating predictions by trained machine learning models. These techniques may increase a number (and diversity) of examples within an initial training dataset of sentences by extracting a subset of words from the existing training dataset of sentences. The extracted subset includes no stopwords and fewer content words than found in the initial training dataset. The remaining words may be re-ordered. Using the extracted and re-ordered subset of words, the dataset generation model produces a second set of sentences that are different from the first set. The second set of sentences may be used to increase a number of examples in classes with few examples.

### TECHNICAL FIELD

The present disclosure relates to training machine learning models. In particular, the present disclosure relates to augmenting data sets used for machine learning models.

### BACKGROUND

Machine learning models are being applied to an ever increasing diversity of tasks, from complex analyses to more mundane tasks. In many situations, particularly for more complicated analyses, the quality of the machine learning output is a function of the quality of the data used to train the machine learning model. For example, machine learning models that include a classification analysis and that are trained with fewer than 10 examples in a class generally exhibit lower predictive accuracy for these low-example classes when analyzing target data. In some situations, training data with a greater number of examples and/or a greater diversity of examples may improve the precision and accuracy of a machine learning model. However, obtaining training data with a sufficient number of examples can be challenging for some situations.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2 illustrates an example set of operations for improving a diversity of examples within an existing dataset for training a machine learning model, in accordance with one or more embodiments;

FIG. 3 illustrates an example set of operations for expanding a vocabulary associated with a trained natural language processing model, in accordance with one or more embodiments;

FIGS. 4A and 4B are illustrations examples in which the methods 200 and 300 are applied, respectively, in accordance with one or more embodiments; and

FIG. 5 shows a block diagram that illustrates a computer system in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.
1. GENERAL OVERVIEW
2. DATA AUGMENTATION SYSTEM ARCHITECTURE
3. DIVERSIFYING AN EXISTING TRAINING DATASET
4. INCREASING A VOCABULARY OF A NATURAL LANGUAGE PROCESSING (NLP) MACHINE LEARNING MODEL
5. EXAMPLE EMBODIMENT
6. COMPUTER NETWORKS AND CLOUD NETWORKS
7. MISCELLANEOUS; EXTENSIONS
8. HARDWARE OVERVIEW

### 1. General Overview

A machine learning model may be trained using datasets of sentences. One or more embodiments implement a data generation model that augments a training dataset of sentences for training a machine learning model. The data generation model increases a number and diversity of sentences in a training dataset. The data generation model generates new sentences based at least in part on existing sentences in the training dataset.

One or more embodiments generate input sets of words for submission to the data generation model to generate sentences by extracting a subset of words from the existing training dataset of sentences. The extracted subset includes no stopwords and fewer content words than found in the initial training dataset. The words in the subset of content words are re-ordered relative to their order in the initial training dataset and provided to the dataset generation model. Using the extracted and re-ordered subset of words, the dataset generation model produces a second set of sentences. The reduced subset of words and the change in word order provides the dataset generation model more flexibility in generating sentences, thereby increasing sentence diversity. The second set of sentences may then be used as a new training dataset in addition to the initial training dataset of sentences. This process increases the number and diversity of sentences used to train a machine learning model. Also, some of the described embodiments efficiently expand a vocabulary for generating output sentences while maintaining accuracy for a given class of output.

One or more embodiments described in this Specification and/or recited in the claims may not be included in this General Overview section.

### 2. Data Augmentation System Architecture

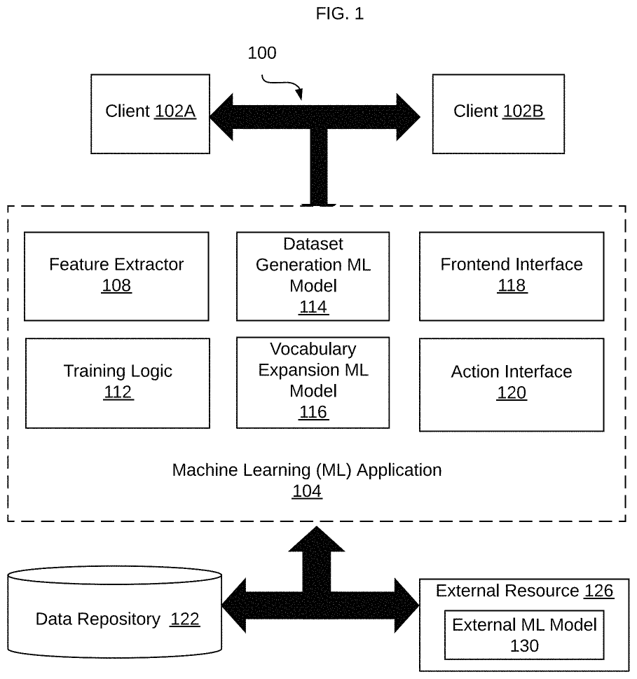

FIG. 1 illustrates a system 100 in accordance with one or more embodiments. As illustrated in FIG. 1, system 100 includes clients 102A, 102B, a machine learning application 104, a data repository 122, and external resource 126. In one or more embodiments, the system 100 may include more or fewer components than the components illustrated in FIG. 1.

The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

The clients 102A, 102B may be a web browser, a mobile application, or other software application communicatively coupled to a network (e.g., via a computing device). The clients 102A, 102B may interact with other elements of the system 100 directly or via cloud services using one or more communication protocols, such as HTTP and/or other communication protocols of the Internet Protocol (IP) suite.

In some examples, one or more of the clients 102A, 102B are configured to receive and/or generate data items that are stored in the data repository 122. The clients 102A, 102B may transmit target data items to the ML application 104 for analysis. In one example, the clients 102A, 102B may send instructions to the machine learning application 104 that initiate processes to augment a training dataset for one or more machine learning models, as described below. The clients 102A, 102B may send instructions to the machine learning ML application 104 to analyze target data items.

The clients 102A, 102B may also include a user device configured to render a graphic user interface (GUI) generated by the ML application 104. The GUI may present an interface by which a user triggers execution of computing transactions, thereby generating and/or analyzing data items. In some examples, the GUI may include features that enable a user to view training data, classify training data, instruct the ML application 104 to execute processes to augment or otherwise increase a number of examples in a training dataset, and other features of embodiments described herein. Furthermore, the clients 102A, 102B may be configured to enable a user to provide user feedback via a GUI regarding the accuracy of the ML application 104 analysis. That is, a user may label, using a GUI, an analysis generated by the ML application 104 as accurate or not accurate. In some examples, using a GUI, the user may cause execution of operations (e.g., a loss function analysis) that measure a degree of accuracy of the analysis produced by the ML application 104. These latter features enable a user to label or otherwise “grade” data analyzed by the ML application 104 so that the ML application 104 may update its training.

The ML application 104 of the system 100 may be configured to generate one or more new training datasets based on an initial dataset. In some embodiments, the ML application 104 may process a generated training dataset to include additional examples not included in either of the initial dataset or the new training dataset(s). The ML application 104 may further be configured to use the generated training datasets to improve the training of an already trained ML model and/or train a separate ML model that is external to the ML application 104. In one example illustration, embodiment of the ML application 104 may generate a new natural language processing dataset based on a limited (e.g., containing few examples) initial dataset, and the use the new natural language processing dataset to further train an already trained model and/or train a separate ML model configured for interpreting human generated natural language (e.g., a chatbot). The new natural language processing dataset generated by the ML application 104 and used to train the chatbot may improve the accuracy and operational efficiency of the chatbot operation.

The example of the machine learning application 104 illustrated in FIG. 1 includes a feature extractor 108, training logic 112, a dataset generation ML model 114, a vocabulary expansion ML model 116, a frontend interface 118, and an action interface 120.

The feature extractor 108 may be configured to identify characteristics (e.g., attributes and/or attribute values) in an initial dataset and processes these characteristics for consumption by the ML application 104. In one example, the feature extractor 108 may generate corresponding feature vectors that represent the identified characteristics. For example, the feature extractor 108 may identify attributes within training data and/or “target” data that a trained ML model is directed to analyze. Once identified, the feature extractor 108 may extract characteristics from one or both of training data and target data.

The feature extractor 108 may tokenize some data item characteristics into tokens. The feature extractor 108 may then generate feature vectors that include a sequence of values, with each value representing a different characteristic token. In some examples, the feature extractor 108 may use a document-to-vector (colloquially described as “doc-to-vec”) model to tokenize characteristics (e.g., as extracted from human readable text) and generate feature vectors corresponding to one or both of training data and target data. The example of the doc-to-vec model is provided for illustration purposes only. Other types of models may be used for tokenizing characteristics.

In one specific illustration, the feature extractor 108 may identify words and word phrases in an initial natural language dataset and generate vectors based on the initial natural language dataset. That is, the feature extractor 108 may identify characteristics (e.g., attributes/attribute values, words, phrases, parts of speech, types of words (content/non-content)) associated with the language in the initial dataset, tokenize the attributes. The feature extractor 108 may then generate one or more feature vectors that correspond to the words, phrases, and/or sentences of the initial natural language dataset.

The feature extractor 108 may append other features to the generated feature vectors. In one example, a feature vector may be represented as [f₁, f₂, f₃, f₄], where f₁, f₂, f₃ correspond to characteristic tokens and where f₄ is a non-characteristic feature. Example non-characteristic features may include, but are not limited to, a label quantifying a weight (or weights) to assign to one or more characteristics of a set of characteristics described by a feature vector. In some examples, a label may indicate one or more classifications associated with corresponding characteristics. For example, a label may indicate whether a word (represented by a token in a feature vector) is a content word, which contributes to a meaning of a sentence or phrase, or a non-content word or stop word there performs a grammatical function but does not contribute to meaning of a sentence or phrase (e.g., conjunctions, articles, among others).

As described above, the system 100 may use labeled data for training, re-training, and applying its analysis to new (target) data. The feature extractor 108 may optionally be applied to new data (yet to be analyzed) to generate feature vectors from the new data. These new data feature vectors may facilitate analysis of the new data by one or more ML models, as described below.

In some examples, the training logic 112 receives a set of data items as input (i.e., a training corpus or training data set). Examples of data items include, but are not limited to, a dataset of natural language vectors (e.g., word, phrase, sentence tokens and corresponding labels). The data items used for training may also be associated with one or more attributes, such as those described above in the context of the feature extractor 108.

In some examples the training logic 112 may receive a training dataset. The training logic 112 may then train one or more machine learning models, as described below. In some examples, training data used by the training logic 112 to train a machine learning model includes feature vectors of data items that are generated by the feature extractor 108, described above. For examples described below related to natural language processing, embodiments of the training dataset used by the training logic may include a publicly or commercially available training dataset. Examples of publicly available NLP datasets include, but are not limited to, those available from commoncrawl (commoncrawl.org) and Wikipedia®.

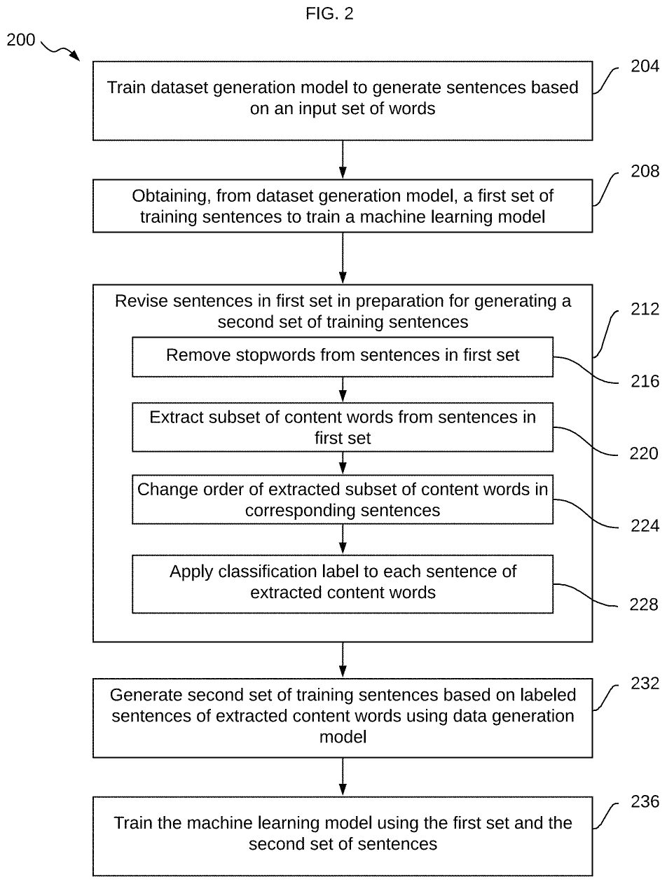

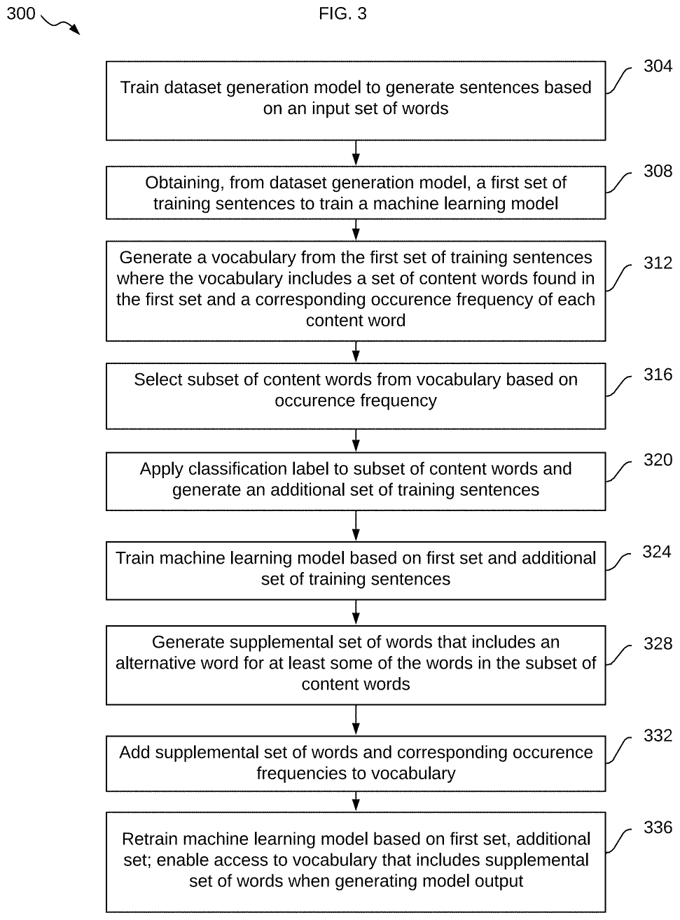

In other embodiments, the training logic 112 may be applied primarily to re-training operations using revised and/or expanded training datasets generated according to the techniques described in FIGS. 2 and 3.

In one example, described below in the context of FIG. 2, the training logic 112 may train and/or re-train a dataset generation ML model 114 using new examples generated according to the techniques described below in the context of FIG. 2. The training logic 112 may then be used to train an external ML model 130 using the initial training dataset and also using any new datasets generated according to the techniques described in the context of FIG. 2.

The training logic 112 may be in communication with a user system, such as clients 102A, 102B. The clients 102A,102B may include an interface used by a user to apply labels to the electronically stored training data set.

In some examples, dataset generation ML model 114 may include one or both of supervised machine learning algorithms and unsupervised machine learning algorithms. In some examples, such as those described below in the context of FIGS. 2 and 3, the dataset generation ML model 114 may be an ML model that is adapted for various aspects of natural language processing (NLP).

For example, one embodiment of the dataset generation ML model 114 is a “sequence to sequence” model (“seq2seq”) that is trained to receive a labeled first sequence of tokens (e.g., corresponding to words) and generate a different, second sequence of tokens consistent with the label applied to the first sequence. In some examples, input to and output from the dataset generation ML model 114 may include those of grammatically correct natural language sentences and/or phrases that include both content word and non-content words.

The dataset generation ML model 114 may be configured to further processes the initially generated datasets from the dataset generation ML model 114. For example, the dataset generation ML model 114 may process a previously generated dataset by removing “stopwords” from one or more sentences and/or phrases in a dataset. As known in natural language processing, “stopwords” are those words used in a phrase and/or sentence that perform a grammatical function but do not contribute directly to the meaning or content of a sentence. Examples of stopwords include, but are not limited to, conjunctions (e.g., “and,” “but”), articles (e.g., “a,” “the”), some linking verbs and auxiliary verbs (e.g., “is,” “are,” “be,”), among others.

By removing these stopwords, the dataset generation ML model 114 improves the operation of the system in several ways. First, removing stopwords reduces the number of words that are analyzed in subsequent processes thereby increasing the computational efficiency and speed of the processes described below. Second, removing stopwords enables the system more flexibility in generating examples by re-ordering words. As explained below in the context of FIG. 2, one technique of increasing a number of examples in a training dataset (particularly a training dataset with a limited number of examples per class) is to re-order a subset of words (e.g., one or more of the sequences of words) in a class. By removing the stopwords, the system is better able to re-order words from an initial sequence to a difference sequence because the system is free to choose different stopwords to produce a different sequence than in the initial sequence that is still grammatically correct. This in turn beneficially increases a number of examples, even for classes with few (e.g., fewer than 10, fewer than 5) examples. Enabling the system to re-order words in a sequence by removing stopwords also has the additional beneficial effect of preventing a model from being trained to associate words in a specific order (e.g., that of the training example) which would limit the sophistication and accuracy of the model.

In another example, dataset generation ML model 114 improves the operation of the system by removing a subset of content words (i.e., non stopwords) from a training dataset and, in some embodiments, altering an order of the remaining content words. This example operations has many of the same benefits described above with the removal of stopwords. In particular, removing a subset of content words increases a number of possible combinations of the remaining words when the system generates additional examples for a training dataset.

In addition to the specific ML models described above, any one or more of the ML models of the system 100 may include any of a number of different types of ML models that have been adapted to execute the operations described below. In some examples, any one or more of the ML models of the system 100 may be embodied by linear regression, logistic regression, linear discriminant analysis, classification and regression trees, naïve Bayes, k-nearest neighbors, learning vector quantization, support vector machine, bagging and random forest, boosting, back propagation, neural network, and/or clustering models. In some examples, multiple trained ML models of the same or different types may be arranged in a ML “pipeline” so that the output of a prior model is processed by the operations of a subsequent model. In various examples, these different types of machine learning algorithms may be arranged serially (e.g., one model further processing an output of a preceding model), in parallel (e.g., two or more different models further processing an output of a preceding model), or both.

The vocabulary expansion ML model 116 identifies content words in a classified sentence or phrase and generates replacement words for one or more of the identified content words that are consistent with the classification. In some examples, the vocabulary expansion ML model 116 may by instantiated as a masked language trained ML model. The vocabulary expansion ML model 116 may identify synonyms or other types of alternative words. In some examples, the vocabulary expansion ML model 116 includes mechanisms to evaluate a similarity between the newly selected “replacement” word and the masked word or evaluate a consistency of a sentence using the replacement work with a classification label. In one example, a loss function and/or a similarity score may be used to generate these evaluations.

Other configurations of the dataset generation ML model 114 and the vocabulary expansion ML model 116 may include additional elements or fewer elements.

The frontend interface 118 manages interactions between the clients 102A, 102B and the ML application 104. In one or more embodiments, frontend interface 118 refers to hardware and/or software configured to facilitate communications between a user and the clients 102A,102B and/or the machine learning application 104. In some embodiments, frontend interface 118 is a presentation tier in a multitier application. Frontend interface 118 may process requests received from clients and translate results from other application tiers into a format that may be understood or processed by the clients.

For example, one or both of the client 102A, 102B may submit requests to the ML application 104 via the frontend interface 118 to perform various functions, such as for labeling training data and/or analyzing target data. In some examples, one or both of the clients 102A, 102B may submit requests to the ML application 104 via the frontend interface 118 to view a graphic user interface related to natural language processing analysis. In still further examples, the frontend interface 118 may receive user input that re-orders individual interface elements.

Frontend interface 118 refers to hardware and/or software that may be configured to render user interface elements and receive input via user interface elements. For example, frontend interface 118 may generate webpages and/or other graphical user interface (GUI) objects. Client applications, such as web browsers, may access and render interactive displays in accordance with protocols of the internet protocol (IP) suite. Additionally or alternatively, frontend interface 118 may provide other types of user interfaces comprising hardware and/or software configured to facilitate communications between a user and the application. Example interfaces include, but are not limited to, GUIs, web interfaces, command line interfaces (CLIs), haptic interfaces, and voice command interfaces. Example user interface elements include, but are not limited to, checkboxes, radio buttons, dropdown lists, list boxes, buttons, toggles, text fields, date and time selectors, command lines, sliders, pages, and forms.

In an embodiment, different components of the frontend interface 118 are specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, the frontend interface 118 is specified in one or more other languages, such as Java, C, or C++.

The action interface 120 may include an API, CLI, or other interfaces for invoking functions to execute actions. One or more of these functions may be provided through cloud services or other applications, which may be external to the machine learning application 104. For example, one or more components of machine learning application 104 may invoke an API to access information stored in a data repository (e.g., data repository 122) for use as a training corpus for the machine learning (ML) application 104. It will be appreciated that the actions that are performed may vary from implementation to implementation.

In some embodiments, the machine learning application 104 may access external resources 126, such as cloud services. Example cloud services may include, but are not limited to, social media platforms, email services, short messaging services, enterprise management systems, and other cloud applications. Additional embodiments and/or examples relating to computer networks are described below in Section 6, titled “Computer Networks and Cloud Networks.”

In some examples, the external resource 126 may include an external ML model 130 that is trained using the training datasets generated by the ML application 104. In one example, training datasets generated by the ML application 104 may be used to train a user-facing natural language processing applications, such as a chatbot (for instant text communications) or an interactive voice recognition (IVR) system.

Action interface 120 may serve as an API endpoint for invoking a cloud service. For example, action interface 120 may generate outbound requests that conform to protocols ingestible by external resources. Action interface 120 may process and translate inbound requests to allow for further processing by other components of the machine learning application 104. The action interface 120 may store, negotiate, and/or otherwise manage authentication information for accessing external resources. Example authentication information may include, but is not limited to, digital certificates, cryptographic keys, usernames, and passwords. Action interface 120 may include authentication information in the requests to invoke functions provided through external resources.

In one or more embodiments, data repository 122 may be any type of storage unit and/or device (e.g., a file system, database, collection of tables, or any other storage mechanism) for storing data. Further, data repository 122 may each include multiple different storage units and/or devices. The multiple different storage units and/or devices may or may not be of the same type or located at the same physical site. Further, data repository 122 may be implemented or may execute on the same computing system as the ML application 104. Alternatively or additionally, data repository 122 may be implemented or executed on a computing system separate from the ML application 104. Data repository 122 may be communicatively coupled to the ML application 104 via a direct connection or via a network.

Information related to target data items and the training data may be implemented across any of components within the system 100. However, this information may be stored in the data repository 122 for purposes of clarity and explanation.

In an embodiment, the system 100 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, and/or a client device.

### 3. Diversifying an Existing Training Dataset

FIG. 2 illustrates an example set of operations, collectively referred to as the method 200, for increasing a diversity of examples in a training dataset, such as for a training dataset with few examples (e.g., fewer than 10, fewer than 5), or a class within a training dataset with few examples, in accordance with one or more embodiments. Training datasets generated according to the method 200 may be used to train other machine learning models, such as chatbots and IVR models. When trained with models generated according to the method 200, the other machine learning models illustrate improved accuracy in their predictions of natural language received from a user.

One or more operations illustrated in FIG. 2 may be modified, rearranged, or omitted all together. Accordingly, the particular sequence of operations illustrated in FIG. 2 should not be construed as limiting the scope of one or more embodiments.

The method 200 may begin by first training a dataset generation model to generate sentences (or phrases) based on an input set of words (operation 204). In one example, a dataset generation model may include a sequence to sequence (“seq2seq”) model that receives an input set of words in a first sequence and then generates a grammatically correct sentence using the words in the input set that are arranged in a second sequence. One specific embodiment of a sequence to sequence that may be used in this context is the “T5” pre-trained sequence to sequence model. Other embodiments of the dataset generation model may engage other types of natural language processing models or trained machine learning models, some of which are indicated above in the context of FIG. 1.

Regardless of the specific dataset generation model used, the method 200, continues with obtaining from the dataset generation model a set of sentences that may be used to re-train (or improve the training of) the dataset generation model that produced the set of sentences and/or train a different machine learning model, such the chatbot or IVR system described above (operation 208). The operation 208 may include sentences that, as described above, have too few examples to effectively train a machine learning model so that it generates accurate, relevant, and/or grammatically correct predictions based on input data (e.g., text communications received from a human correspondent).

For example, the training set initially received from the dataset generation model may include sentences that are grouped into one or more classes. The sentences generated by the dataset generation model may be represented as corresponding multi-dimensional vectors in which words and/or phrases of the sentences are represented by corresponding tokens. The class that each sentence (or, more specifically, the vector representation of each sentence) is associated with may be indicated by a label. The number of sentences in one or more of the classes may, in some examples, be too small to be statistically significant. In other examples, the number of sentences may be too low or otherwise have a number of sentences that is insufficient to train a different ML model to generate accurate predictions.

In some cases, the set of training sentences may be too similar to one another. This lack of diversity in the examples used to train a different ML model may also be problematic. That is, if the diversity of samples is too small, then an ML model training using the too similar training sentences will generate predictions that are inaccurate or not relevant to subsequent target data inputs.

To overcome these deficiencies, the method 200 may revise sentences in the set of training sentences to generate another set of training sentences (operation 212). This additional set of training sentences may be based on the content of the initial set of training sentences. In this way, the number of examples is increased for classes that have too few examples needed for training a model to generate accurate and/or relevant predictions based on target input data. As described below in more detail in the operations 216-232, the revised sentences are generated using the initial set of training sentences. This improves the speed and convenience of training because the system omits the additional steps (and potential errors) of acquiring, preparing, labeling, and otherwise processing an entirely new training dataset.

The system revises the initial training dataset of sentences by first removing stopwords from the sentences of the initial training dataset (operation 216). As explained above, removing stopwords from the sentences has a number of benefits. For example, by removing stopwords, the system improves the diversity of the new examples generated because the system has more flexibility in generating examples by re-ordering words. More specifically, one aspect of diversity in a training dataset is the order of words used in an example sentence. By providing the system with a set of words associated with a particular sentence but without stopwords, the system may generate one, two, or more different examples using the same set of input words but any number of different combinations of stopwords in each of the different, newly generated and grammatically correct example sentences.

In some examples, the system may remove stopwords in the operation 216 by, for example, first identifying stopwords within a vector representation of a sentence. In one example, the system may identify stopwords by applying search criteria, filtering, matching, or other NLP techniques to a vector representation of a sentence. In some examples, the system may apply a label to any stopword tokens during or after the tokenization and/or vectorization process. The system may then apply a filter and/or search criteria using the applied labels. In another example, tokens in a sentence, including stopword tokens, may be associated with metadata, a field name, and/or attribute value that identify a part of speech corresponding to the word, such as an article, conjunction, and the like. The system may then identify stopwords by searching, filtering, or otherwise identifying the stopwords based on the metadata, field name, and/or attribute value corresponding to the stopword. In still other examples, the system may simply use text matching systems (e.g., character recognition, neural networks, classifiers, and other machine learning models) to identify stopwords in a target sentence (or corresponding vector).

Once identified, the system may remove the stopwords by simply deleting the stopwords from a sentence or removing stopword tokens from a vector representation of a sentence.

In addition to removing the stopwords, the system extracts a subset of words from the sentence (or, equivalently, a subset of tokens from a vector corresponding to the sentence) (operation 220). The extracted subset of words includes less than the complete set of words in the initial set of sentences received from the dataset generation model in the operation 208. The extracted subset of words will ultimately be used to generate additional examples for improving the training of one or more machine learning models.

In some examples, the system extracts the words (or equivalently, tokens) and stores the extracted subset of words (corresponding to one or more sentences) in a separate data structure for additional processing. For example, the system may represent the extracted subset of words as a set of tokens associated in a separate vector that corresponds to the extracted subset of words. In other examples, the “extracted” subset of tokens (corresponding to the extracted subset of words) may remain with the first set of words received in the operation 212 and processed according to the operation 216 and merely be individually labeled to indicate their respective selection for the subset.

The system may select the subset of words to be extracted using any of a number of techniques. In one example, the system applies a random selection function to each word (or equivalently, token) that determines whether or not to select a word in the sentence for the subset. The system may select a particular minimum threshold percentage of tokens (but less than 100%) to be selected from the initial set for the subset. In another example, the system may select tokens from a vector using a probabilistic selection function other than random selection. In some examples, the system may bias selection of tokens based on part of speech, word length, type of content word (e.g., based on subject matter associated with the word), or other criteria.

The system may then change an order of the extracted words relative to the order in which the extracted words appeared in the corresponding sentence received in the initial set of training sentences (operation 224). The system may apply any technique to the extracted subset of words to change the order of the words. In some examples, the order of the words is randomized by application of a randomization function. Examples in which the order of remaining words is randomized may be particularly beneficial for refining training of the model by decoupling the order of the words from the predictive analysis of the model. In other words, randomizing the words in a sentence improves the analytical flexibility of a model (when trained in the following operation 236) because the model is not trained to identify a specific order as required for certain input words.

In other examples, the order of the words is changed by application of a systematic function. For example, a first word is moved to either one of a beginning or an end of a sentence and/or a second word is moved to one of a beginning, end, or middle of a sentence.

In some examples, a single word is moved from a first location (corresponding to the location of the word in the operations 216, 220) to a second location different from the first location. In other examples, two, three, or more words are moved from their corresponding locations to corresponding different locations. In still another example, a randomly selected number of words are moved from their respective first locations to different second locations.

This re-ordering (or “shuffling”) process may be executed on each sentence (or the remaining portions of the initially received sentences) of the initial set of sentences receiving in the operation 212.

Once the extracted subset of words is re-ordered, the system may apply a classification label to each of the vector representations corresponding to the sentences processed in the operations 216-224. In some examples, the label is metadata or a token that is added to a vector of the extracted subset of re-ordered tokens. In some examples, the label may be a prefix to the vector (i.e., pre-pended to the beginning of the vector).

In some examples, the classification label is analogous to the labels described above. That is, a classification label indicates a topic, theme, category, or other type of subject matter generalization that the subset of extracted and re-ordered words relates to. In one illustration, a classification label may be “books” for a vector of the following tokens: <fiction>; <non-fiction>; <pages>; <authors>; <best sellers>. In another illustration, a classification label may be “baking” for a vector of the following tokens: <whole grain>; <wheat flour>; <knead>; <bread>; <crust>.

The execution of the operation 212 and the sub-operations 216-228 causes the system to generate a revised set of clauses that are based on the initial set of sentences received from the dataset generation model. The contents of the revised set are described as clauses instead of sentences because they no longer include all of the elements typically needed to form a grammatically correct sentence, such as stopwords or a grammatically correct order or sequence of the remaining content words. However, each clause and its classification label prefix correspond to one of the sentences in the initially received training dataset.

The system then uses the generated revised set of clauses as inputs to the dataset generation model to generate a second set of sentences that may be used to fine tune the training of the dataset generation model (operation 232).

In some examples, the process of generating the second set of sentences begins by the system generating an accounting of content words (i.e., non stopwords) occurring in the initially provided set of training sentences and a corresponding frequency of occurrence for each word in the initially provided set of training sentences. These occurrence frequency data for the of the initially provided words, termed a “vocabulary” for convenience, is analogous to data used to generate a histogram. The vocabulary data may be stored as any convenient data structure.

The system generates the vocabulary using any frequency generating algorithm. For example, the system may first identify each unique token within any of the vectors corresponding to training sentences, initiate a counter for each unique token, and then use NLP or other matching or similarity analysis techniques (e.g., cosine similarity) to identify occurrences of each unique token. Upon detecting a new occurrence of a particular token, the system increments the corresponding counter to cumulatively count the number of occurrences of each word within a training dataset.

The system then selects samples of words (or more precisely, tokens corresponding to the words) from the vocabulary according to the frequency of occurrence of the words. In some examples, a number of tokens selected for a sample may constitute a single content word and in other examples may constitute multiple content words. The system concatenates tokens selected for a sample into a sample vector and pre-pends the vector with a label that corresponds to a classification. The classification label prefix indicates a theme, topic, or generalized characterization of a sentence that the dataset generation model is to produce using the selected sample(s).

The one or more sample vectors (including the prefix content label) are then provided to, and subsequently consumed by, the dataset generation model which produces a sentence for each input sample vector. The sentences produced by this technique are the second set of sentences. Each output sentence is then evaluated as to the quality and/or accuracy in light of the applied label. In some examples, a loss function may evaluate and score each output sentence and/or each token within an output sentence. Other types of algorithms and/or methods may be used to evaluate a quality of one or more output sentences.

These data may then be used to train one or more machine learning models. In some examples, the initial set of training sentences, the second set of (training) sentences, and the output quality measurement may be provided to the dataset generation model itself to improve the training of the model (operation 236). In other examples, these same data may be provided to another machine learning model as an improved data training set. In any case, the techniques described above in the operations 204-232 may improve the accuracy of trained machine learning model predictions and the ability of a model to generate accurate predictions for a wider range of input (or “target”) data for any of several reasons.

In one example, generating, by the dataset generation model, the second set of training sentences from sampled of tokens based on the “shuffled” subset of content words (and corresponding labels) provides new training data examples for a class (designed by a prefix label) even though the individual tokens are also present in the initial training dataset. This is because the order in which the subset of content words are arranged is different from the order in which the content words appear in the initial training dataset. In this way, the dataset generation model is provided with new examples simply by virtue of this different word sequence. This different word sequence has the effect of diffusing any weight inferred by a model on a particular order of words perceived by the model in an initial training data. Furthermore, the relevance of the sentences generated by the dataset generation model is generally still high given that the clause vectors are pre-pended with a content label.

Using the method 200 to increase a diversity of examples in a training dataset has the added benefit of efficiency because the diverse samples are based on an already existing training dataset. The additional effort (computational or otherwise) needed for obtaining, filtering, and classifying an entirely new and distinct dataset is avoided.

### 4. Increasing a Vocabulary of a Natural Language Processing (NLP) Machine Learning Model

FIG. 3 illustrates an example set of operations, collectively referred to as the method 300, for increasing a vocabulary of a training dataset, in accordance with one or more embodiments. A system may use the method 300 in cooperation with the method 200 to further increase a diversity of examples and/or improve an analytical precision of a trained machine learning model, in some examples.

One or more operations illustrated in FIG. 3 may be modified, rearranged, or omitted all together. Accordingly, the particular sequence of operations illustrated in FIG. 3 should not be construed as limiting the scope of one or more embodiments.

Analogous to the method 200, the method 300 may begin by first training a dataset generation model to generate sentences (or phrases) based on an input set of words (operation 304). In one example, a dataset generation model may include a sequence to sequence (“seq2seq”) model that receives an input set of words in a first sequence and then generates a grammatically correct sentence using the words in the input set that are arranged in a second sequence. One specific embodiment of a sequence to sequence that may be used in this context is the “T5” pre-trained sequence to sequence model. Other embodiments of models that may be used for the dataset generation model are other types of natural language processing models, some of which are indicated above in the context of FIG. 1.

As with the method 200, the method 300 continues with obtaining from the dataset generation model a set of sentences that may be used to train a different machine learning model, such the chatbot or IVR system described above (operation 308). In some examples, the operation 308 may involve the optional removal of stopwords, as described above in the context of the operation 216. Also, as with the method 200, while the following description may refer to words, sentences, and clauses, it will be appreciated that this terminology is for convenience of explanation. The system may execute its operations on tokens instead of words, and vector representations that are concatenated tokens the correspond to (and are representations of) sentences or clauses.

The system then generates a vocabulary that denominates a frequency of occurrence of each unique word (i.e., token) within the first dataset of training sentences (operation 312). The system may use the techniques described above in context of the operation 232 to generate the vocabulary for the operation 312.

Then, similar to some of the processes described above in the context of FIG. 2, the system then selects samples of words (or more precisely, tokens corresponding to the words) from the vocabulary according to the frequency of occurrence of the words (operation 316). In some examples, a number of tokens selected for a sample may constitute a single content word and in other examples may constitute multiple content words.

The system concatenates tokens selected for a sample based on occurrence frequency into a sample vector and pre-pends the vector with a label that corresponds to a classification (operation 320). The classification label prefix indicates a theme, topic, or generalized characterization of a sentence that the dataset generation model is to produce using the selected sample(s).

The one or more sample vectors (including the prefix content label) are then provided to, and subsequently consumed by, the dataset generation model which produces a sentence for each input sample vector and pre-pended classification label (operation 320). The output sentence is then evaluated as to the quality and/or accuracy in light of the applied label. In some examples, a loss function may evaluate and score each output sentence and/or each token within an output sentence. Other types of algorithms and/or methods may be used to evaluate a quality of one or more output sentences.

These data—namely the first of training sentences, the sentences produced from the sampled vocabulary tokens, and the loss function data—may then be used to train one or more machine learning models (operation 324). In some examples, the initial set of training sentences, the second set of training sentences, and the output quality measurement may be provided to the dataset generation model itself to improve the training of the model. In other examples, these same data may be provided to another machine learning model as an improved data training set. In any case, the techniques described above in the operations may improve the accuracy of trained machine learning model predictions and the ability of a model to generate accurate predictions for a wider range of input (or “target”) data for any of several reasons.

In various aspects, the preceding operations of the method 300 have some parallels to some of the operations of the method 200 with regard to expanding a number of examples within any particular class of training data. The method 300 may further enhance the analytical capabilities of a machine learning model by, via operations 328-336, increasing a vocabulary available to the trained machine learning model, which in turn increases sophistication and quality of machine learning model outputs.

The system may access the vocabulary whose tokens and frequencies are based on the first training dataset and generate a supplemental set of words (and corresponding tokens) that are alternatives to at least some of the words in the vocabulary, thereby increasing the diversity of words in the vocabulary (operation 328).

In one example, the system may generate a supplemental set of words by using another trained machine learning model. In one illustration a “masked language model” may be applied to any one or more identified tokens in a sentence vector, along with its classification label prefix. In some cases, the system systematically masks each word in a vector and identifies corresponding supplemental words. Reference by the system to the classification label of the vector being analyzed guides the ML model used to generate supplemental vocabulary words in the same class of word that is to be selected.

In this example, the masked language model operates by concealing (or “masking”) one or more words in a sentence from the model and then predicting the concealed word. This may produce an alternative word, which may then be added to the vocabulary. This process may be executed iteratively to any one or more sample sentences and/or any one or more content words within the one or more sentences. The output of this iterative process are new words not present in the vocabulary generated in the operation 312. In this way, the system increases the diversity of words in the vocabulary. In some examples, the new words are synonyms of the masked word.

Examples of masked language models include those associated with Google® BERT®, and RoBERTa. In some examples, one or more tokens may be associated with a pre-fix classification label to further improve a relevance of the predicted word to that of the masked word. More generally, in some examples, a word is selected by a contextual word embedding model (e.g., such as RoBERTa). In other examples, a word is selected by a non-contextual word embedding model.

The system may employ techniques other than the contextual and non-contextual word embedding models to generate alternative words for the vocabulary. For example, in some cases the system may refer to a publicly available natural language database (e.g., Wikipedia®) or a commercially available natural language database to identify supplemental word in the same class as the analyzed token.

The system may then add the supplemental words and/or increment occurrence frequencies to the vocabulary (operation 332). For situations in which the supplemental word is the same as the masked word or is different from the masked word but is already in the vocabulary, the system may increment the corresponding pre-existing occurrence frequency accordingly. For situations in which the supplemental word is not in the vocabulary, the system may add the supplemental word to the vocabulary and increment the occurrence frequency.

The system may then generate machine learning model outputs based on the vocabulary that includes the supplemental set of words and occurrence frequencies in addition to any pre-existing words from the first set of training sentences (operation 336). In some examples, sentences generated using the supplement set of words and the initial set of words in the vocabulary may be used for subsequent machine learning model training.

In some examples, the system may use a “filtering” technique to assure that sentences generated using the expanded vocabulary (including both supplemental and initial words and corresponding frequencies) maintain relevance to a prescribed class.

In one example, this filtering technique begins by generating a vector space (e.g., a 512 dimensional space) using the sentences from the first set of training sentence. Using these parameters to define the dimensions of the space, the system then places of vectors of the first set of training sentences within the space. The system includes the pre-pended classification label so that each sentence in the multi-dimensional vector space is associated with its corresponding class.

The system can analyze the quality of output sentences (e.g., output sentences generated by the trained ML model using the expanded vocabulary based on inputs) by analyzing a distance between an output sentence and its neighboring vectors and/or clusters of vectors representing the first training data set. For example, if an output vector that is associated with a particular class is located in vector space closest to one or more other vectors also associated with the particular class, then the system may determine that the output vector is accurate. Accurate output sentences and their corresponding vectors may be retained in the system and used according to the methods 200 and 300 (e.g., supplementing vocabularies and the like).

However, if the nearest neighbors to the output sentence belong to another class that is different from the particular class of the output sentence, the system may determine that the output sentence is not accurate. In this case, the output sentence is removed or “filtered” from the system so as to not reduce the accuracy of the model. This evaluation may also be incorporated into a recursive training process so that the tokens used in the rejected output vector are dis-associated from the classification label (or negatively associated with the classification label).

In one example, the above process may be executed using a nearest neighbor model. In one example, the above process may be executed using a k-nearest neighbor model. In other examples, the above process may be executed using a clustering model. In other examples, the similarity between an output vector being analyzed and its nearest neighbor or k-nearest neighbors may be quantified using a similarity score (e.g., cosine similarity). Similarity scores above a threshold indicate that the output vector should be retained. Similarity scores below a threshold indicate that the output vector should be removed from the model.

In still other examples, the system may use a comparison of a distance between the output vector and (1) a centroid of a nearest cluster and (2) a centroid of the nearest cluster having the same class as the output vector. If the distance from the output vector to the nearest cluster is less than the distance between the output vector and a centroid of the nearest cluster having the same class as the output vector, then the system will determine that the output vector is more similar to a different class than its labeled class and should be omitted from the model. Analogously, if the distance from the output vector to the nearest cluster is the same as the distance to the centroid of the nearest cluster having the same class as the output vector, then the system will determine that the output vector is sufficiently similar to its labeled class and should be retained by the model. This process may be adapted to accommodate degrees of similarity between classes so that similar classes (but not the same) are accepted based on a similarity threshold.

### 5. Example Embodiment

A detailed example is described below for purposes of clarity. Components and/or operations described below should be understood as one specific example which may not be applicable to certain embodiments. Accordingly, components and/or operations described below should not be construed as limiting the scope of any of the claims.

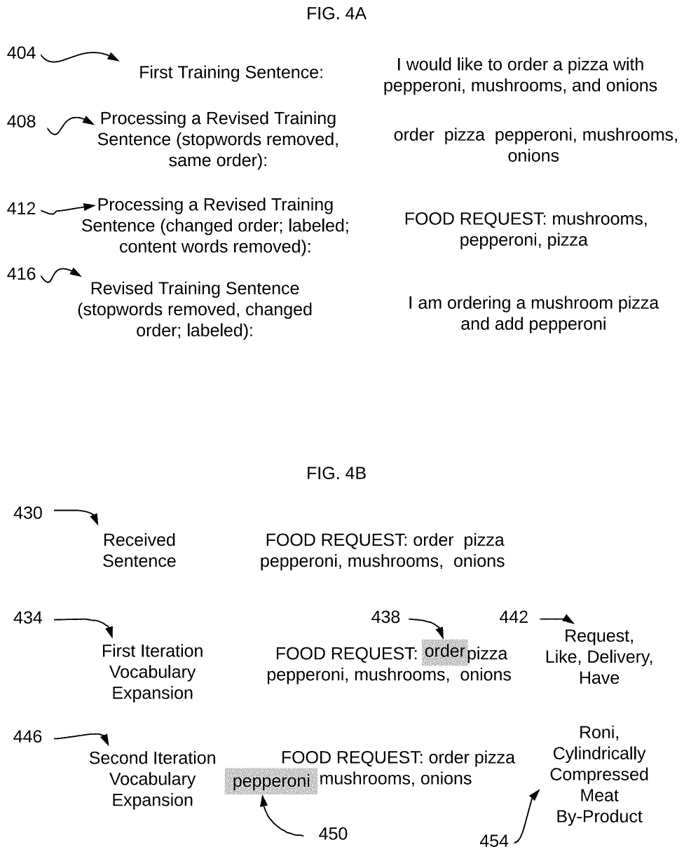

FIG. 4A illustrates an example application of the method 200. A dataset generation model generates a first training sentence 404 that states “I would like to order a pizza with pepperoni, mushrooms, and onions.” FIG. 4A shows the generation of a revised training sentence in a series of progressive stages 408, 412, and 416. In stage 408, the system removes stopwords from the first training sentence 404 to produce a clause of “order pizza pepperoni, mushrooms, onions.” Next, in stage 412, the system applies a classification label “FOOD REQUEST” to the remaining words, changes an order of the remaining content words, and removes some of the content words. This produces a set of words “mushrooms,” “pepperoni,” and “pizza.” The method 200 concludes in stage 416 by generating a revised training sentence that states “I am ordering a mushroom pizza and add pepperoni.” This may then be used as another training sentence for a machine learning model with the various advantages described above in the context of FIG. 2.

FIG. 4B illustrates an example application of the method 300 for expanding a vocabulary. A received sentence 430 includes a classification label (“FOOD REQUEST”), with content words “order,” “pizza,” “pepperoni,” mushrooms,” “onions.” The system executes one iteration of the vocabulary expansion technique described above by masking a word 438 (“order”) which is indicated as masked by shading in the FIG. 4B. The system then generates alternative vocabulary words 442 of “request,” “like,” delivery,” and “have.”

The system executes another iteration 446 of the vocabulary expansion technique on a different word 450, also indicated by shading in the figure. This process produces alternative words 454 for “pepperoni” as “roni” and “cylindrically compressed meat by-product.” The words 442 and 454 may be added to a vocabulary, as described above.

### 6. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 7. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

### 8. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

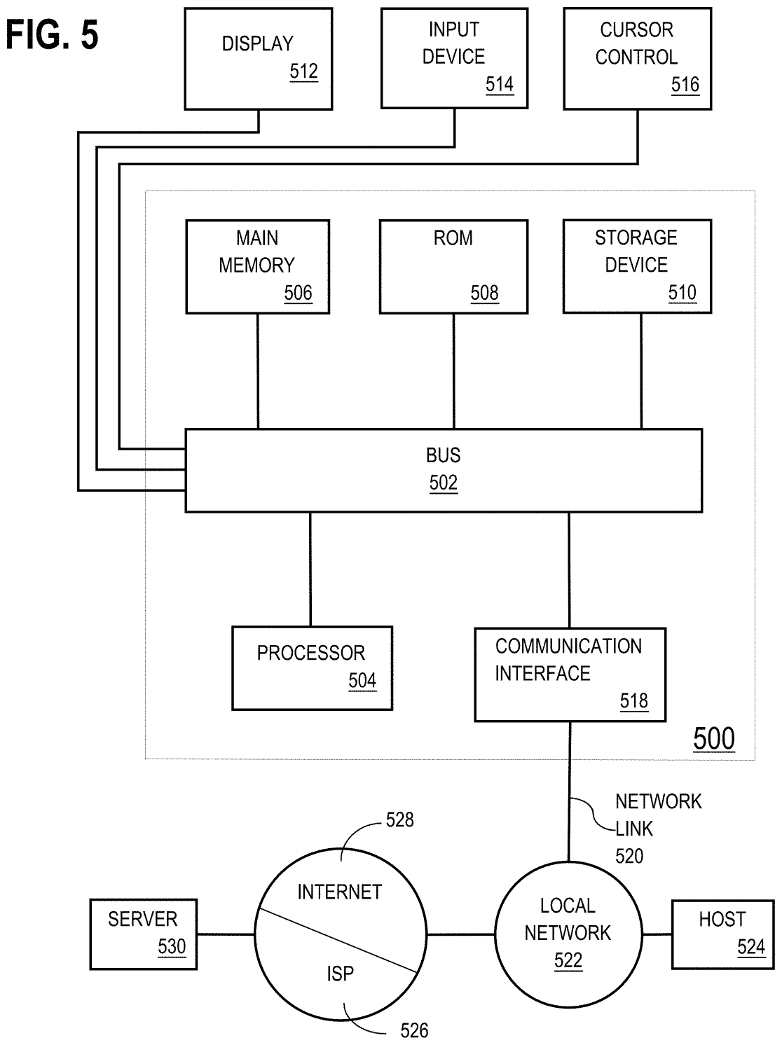

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. One or more non-transitory computer-readable media storing instructions, which when executed by one or more hardware processors, cause performance of operations comprising:
obtaining an initial dataset from a dataset generation model, the initial dataset comprising a first plurality of sentences to train a machine learning model;
generating a new dataset comprising a second plurality of sentences based on the initial dataset at least by:
extracting a first set of words from a first sentence of the first plurality of sentences;
applying the first set of words as an input set to the dataset generation model to generate a second sentence of the second plurality of sentences; and
training the machine learning model based on the initial dataset comprising the first plurality of sentences and the new dataset comprising the second plurality of sentences.

2. The media of claim 1, wherein the machine learning model comprises a natural language processing machine learning model that, based on the training operation, generates a third sentence from a set of target words.

3. The media of claim 2, wherein the natural language processing machine learning model comprises a sequence to sequence type machine learning model.

4. The media of claim 1, further comprising:
applying a classification label to the extracted first set of words; and
applying the labeled first set of words as the input set to the dataset generation model.

5. The media of claim 1, wherein:
a starting set words of the first sentence comprises a first subset of content words in a first sequence and a second subset of stop words;
the first set of words extracted from the first sentence comprises the first subset of content words; and
generating the second sentence further comprises changing the first sequence of the first subset of content words to a second sequence of the first subset of content words that is different from the first sequence.

6. The media of claim 5, wherein the second sequence of the first subset of content words is a random sequence.

7. The media of claim 1, further comprising training the dataset generation model to generate sentences based on an input set of one or more words.

8. The media of claim 7, wherein:
training the dataset generation model to generate sentences further comprises associating a classification label to the extracted first set of words prior to applying the first set of words as the input to the dataset generation model, wherein the classification label indicates a theme associated with the extracted first set of words; and
the second sentence generated by the dataset generation model comprises the classification label.

9. The media of claim 1, further comprising:
extracting a superset of words from the first plurality of sentences, the superset of words including a set of content words and not include a set of stop words;
generating a vocabulary comprising (1) the superset of words and (2) a corresponding frequency of occurrence of each word in the superset of words;
selecting, from the vocabulary, a first subset of words based on corresponding frequencies of occurrence in the vocabulary of the words in the first subset;
applying a classification label and the first subset of words as an additional input set to the dataset generation model to generate an additional dataset comprising sentences of a third plurality of sentences; and
training the machine learning model based on the initial dataset comprising the first plurality of sentences, the new dataset comprising the second plurality of sentences, and the additional dataset of the third plurality of sentences.

10. The media of claim 9, wherein generating the vocabulary further comprises:
generating a supplemental set of words comprising at least one alternative word for each word in the first set of words;
adding the supplemental set of words and corresponding frequencies of occurrence for each word to the vocabulary to form a combined vocabulary; and
using the supplemental set of words as inputs to the machine learning model.

11. The media of claim 10, wherein the at least one alternative word is a synonym.

12. A method comprising:
obtaining an initial dataset from a dataset generation model, the initial dataset comprising a first plurality of sentences to train a machine learning model;
generating a new dataset comprising a second plurality of sentences based on the initial dataset at least by:
extracting a first set of words from a first sentence of the first plurality of sentences;
applying the first set of words as an input set to the dataset generation model to generate a second sentence of the second plurality of sentences; and
training the machine learning model based on the initial dataset comprising the first plurality of sentences and the new dataset comprising the second plurality of sentences.

13. The method of claim 12, wherein the machine learning model comprises a natural language processing machine learning model that, based on the training operation, generates a third sentence from a set of target words.

14. The method of claim 13 wherein the natural language processing machine learning model comprises a sequence to sequence type machine learning model.

15. The method of claim 12, further comprising:
applying a classification label to the extracted first set of words; and
applying the labeled first set of words as the input set to the dataset generation model.

16. The method of claim 12, wherein:
a starting set words of the first sentence comprises a first subset of content words in a first sequence and a second subset of stop words;
the first set of words extracted from the first sentence comprises the first subset of content words; and
generating the second sentence further comprises changing the first sequence of the first subset of content words to a second sequence of the first subset of content words that is different from the first sequence.

17. The method of claim 16, wherein the second sequence of the first subset of content words is a random sequence.

18. The method of claim 12, further comprising training the dataset generation model to generate sentences based on an input set of one or more words.

19. The method of claim 18, wherein:
training the dataset generation model to generate sentences further comprises associating a classification label to the extracted first set of words prior to applying the first set of words as the input to the dataset generation model, wherein the classification label indicates a theme associated with the extracted first set of words; and
the second sentence generated by the dataset generation model comprises the classification label.

20. The method of claim 12, further comprising:
extracting a superset of words from the first plurality of sentences, the superset of words including a set of content words and not include a set of stop words;
generating a vocabulary comprising (1) the superset of words and (2) a corresponding frequency of occurrence of each word in the superset of words;
selecting, from the vocabulary, a first subset of words based on corresponding frequencies of occurrence in the vocabulary of the words in the first subset;
applying a classification label and the first subset of words as an additional input set to the dataset generation model to generate an additional dataset comprising sentences of a third plurality of sentences; and
training the machine learning model based on the initial dataset comprising the first plurality of sentences, the new dataset comprising the second plurality of sentences, and the additional dataset of the third plurality of sentences.
